(19) United States
(12) Patent Application Publication
(10) Pub. No.: US 2015/0331921 A1
(43) Pub. Date: Nov. 19, 2015

(54) SIMULATION SYSTEM AND SIMULATION METHOD

(71) Applicant: HITACHI, LTD., Chiyoda-ku, Tokyo (JP)

(72) Inventors: Yasuyuki KUDO, Tokyo (JP); Chihiro YOSHIMURA, Tokyo (JP); Masaki HAMAMOTO, Tokyo (JP); Junichi MIYAKOSHI, Tokyo (JP)

(73) Assignee: Hitachi, Ltd., Tokyo (JP)

(21) Appl. No.: 14/758,104

(22) PCT Filed: Jan. 23, 2013
(86) PCT No.: PCT/JP2013/051234

§ 371 Date: Jun. 26, 2015

(51) Int. Cl. G06F 17/30; G06T 11/20; G06F 3/0482; G06F 3/0488; G06F 17/50; G06F 3/0484

(52) U.S. Cl. CPC G06F 17/30572; G06F 17/5009; G06F 3/04847; G06F 3/0482; G06F 3/0488; G06T 11/206

(57) ABSTRACT

An object of the invention is to provide a simulation system and a simulation method which are capable of efficiently presenting a simulation result which is valuable to a user. The invention achieves the above-mentioned object by performing simulation, displaying a plurality of simulation results as samples, receiving an input of information on a user's evaluation with respect to each of the displayed results by a user interface, and outputting a group of simulation results on the basis of the input information.

### TECHNICAL FIELD

The present invention relates to a simulation system and a simulation method, and more particularly, to a system and a method using a user interface.

### BACKGROUND ART

PTL 1 discloses a technique as a background art of the present technical field. This publication discloses a method of presenting only results satisfying a certain condition when a user inputs the condition with respect to a plurality of simulation results. In addition, PTL 2 discloses a technique as another background art. This publication discloses a method of presenting a certain simulation result, causing a user to determine whether or not the result is similar to actual behavior, and changing an initial value when the result is different from the actual behavior to thereby display a result obtained by performing simulation again.

### CITATION LIST

### Patent Literature

PTL 1: U.S. Pat. No. 7,233,921

PTL 2: US 2006/0055705

### SUMMARY OF INVENTION

### Technical Problem

A simulation system for predicting outcomes in the real world has attracted attention as a tool for efficiently designing and operating social infrastructure, a city, and the like. In this simulation system, the targeted real world is a so-called complex system, and an extremely large number of elements interact with each other, and thus it is difficult to accurately simulate an event. Accordingly, it is easier in many cases to obtain user satisfaction when a plurality of possibilities are presented than when one simulation result is shown. However, even when a large number of simulation results are blindly presented, it is difficult for a user to find valuable results among the results.

In addition, in a case of prediction simulation of the real world or the like, it is difficult in many cases to determine whether or not a simulation result is valuable using only characteristics of the result. For example, if it is possible to induce new awareness by knowing a process leading to a result having poor characteristics, the result can be referred to as being valuable. In contrast, even when a result has good characteristics, the result may not be referred to as being valuable in terms of the obtainment of awareness if the result is completely the same as a user's prediction.

Here, the above-mentioned method disclosed in PTL 1 limits a range in which presentation is performed using only characteristics of a simulation result. Accordingly, as in the above-mentioned example, it is actually difficult to obtain new awareness from a result having poor characteristics.

On the other hand, in the method disclosed in PTL 2, a guideline in which setting a valuable result is approximated at the time of changing an initial value is not taken into consideration. Accordingly, there is the possibility that a large number of simulations having different initial values are repeated in order to obtain a valuable result.

The invention is contrived in view of the above-mentioned problems, and an object thereof is to provide a simulation system capable of efficiently presenting a simulation result which is valuable to a user.

### Solution to Problem

In order to solve the above-mentioned problems, for example, configurations described in claims are adopted.

The present application includes a plurality of means for solving the above-mentioned problems. As an example, the above-mentioned problems are solved by performing simulation, displaying a plurality of simulation results as samples, receiving an input of information on a user's evaluation with respect to each of the displayed results by a user interface, and outputting a group of simulation results on the basis of the input information.

### Advantageous Effects of Invention

According to the invention, it is possible to efficiently present a simulation result which is valuable to a user.

### BRIEF DESCRIPTION OF DRAWINGS

FIG. 1 is a block diagram illustrating functions of a simulation system.

FIG. 2 is a flow chart illustrating the operation of the simulation system.

FIG. 3 is a flow chart illustrating presentation range adjustment of simulation results.

FIG. 4 is a screen layout diagram illustrating functions of a terminal.

FIG. 5 is a diagram illustrating the operation of presentation range adjustment of simulation results.

FIG. 6 is a diagram illustrating the operation of presentation range adjustment of simulation results.

FIG. 7 is a block diagram illustrating functions of a simulation system.

FIG. 8 is a flow chart illustrating the operation of the simulation system.

FIG. 9 is a diagram illustrating the operation of presentation range adjustment of simulation results.

FIG. 10 is a block diagram illustrating a hardware configuration.

### DESCRIPTION OF EMBODIMENTS

Hereinafter, examples will be described with reference to the accompanying drawings.

### FIRST EXAMPLE

In the present example, a description will be given of an example of a simulation system capable of visualizing a simulation result and interactively adjusting a presentation range of the visualized result in response to a user's request. Meanwhile, agent-based simulation (ABS) which is effective in analyzing and predicting the movement of the real world is used as an example of a simulation method in the present example.

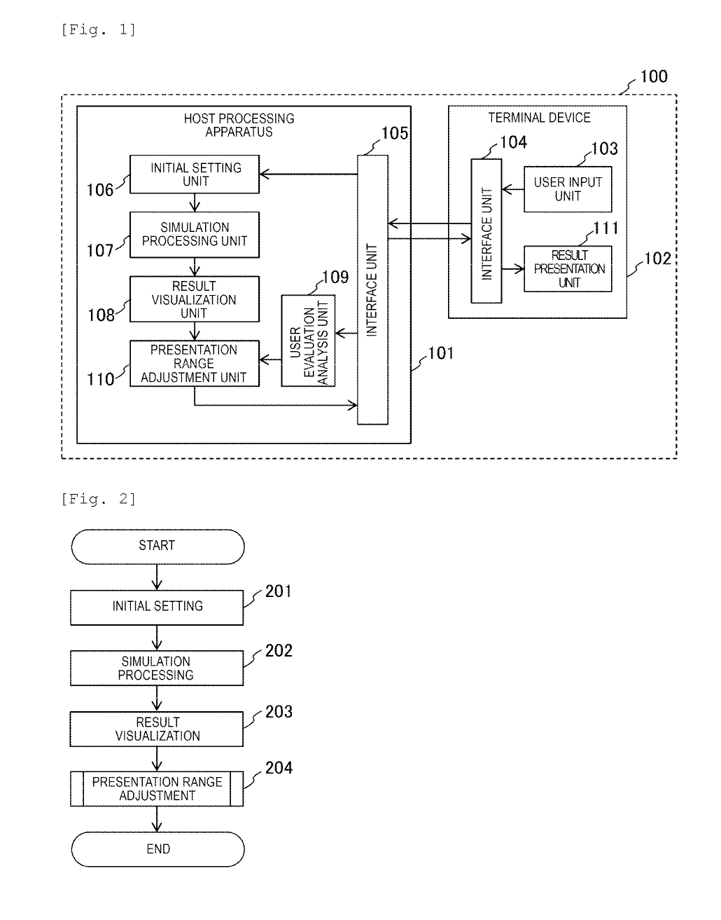

FIG. 1 is a functional block diagram of a simulation system 100 according to the present example. The simulation system 100 includes a host processing apparatus 101 and a terminal device 102.

The terminal device 102 includes a user input unit 103, an interface unit 104, and a result presentation unit 111. For example, the terminal device 102 is a portable terminal and is, for example, a tablet terminal. The host processing apparatus 101 includes an interface unit 105, an initial setting unit 106, a simulation processing unit 107, a result visualization unit 108, a user evaluation analysis unit 109, and a presentation range adjustment unit 110.

FIG. 10 is a block diagram illustrating hardware configurations of the host processing apparatus 101 and the terminal device 102. The host processing apparatus 101 is connected to a base station 1002 that performs wireless communication through a network 1001. The terminal device 102 performs wireless communication with the host processing apparatus 101 through the base station 1002.

The host processing apparatus 101 includes a central processing unit (CPU) 1003, a memory 1004, a storage 1005, and a network interface (I/F) 1006. The CPU 1003 performs computation of each of the initial setting unit 106, the simulation processing unit 107, the result visualization unit 108, the user evaluation analysis unit 109, and the presentation range adjustment unit 110. The memory 1004 stores modules for executing the initial setting unit 106, the simulation processing unit 107, the result visualization unit 108, the user evaluation analysis unit 109, and the presentation range adjustment unit 110, and intermediate processing data from the CPU 1003. The storage 1005 stores modules and data. The network I/F 1006 realizes the interface unit 105. The host processing apparatus 101 is, for example, a server device.

The terminal device 102 includes a CPU 1007, a memory 1008, a storage 1009, a network I/F 1010, and a user interface (I/F) 1011. The CPU 1007 performs computation and the like regarding the user input unit 103, the interface unit 104, and the result presentation unit 111. The memory 1008 stores modules incorporated into the terminal device 102, and intermediate processing data from the CPU 1007. The storage 1009 stores modules and data. The network I/F 1010 realizes the interface unit 104. The user I/F 1011 is a combination of a display device such as, for example, a liquid crystal panel, and a touch panel. The user input unit 103 is realized by a touch panel, and the result presentation unit 111 is realized by a display device.

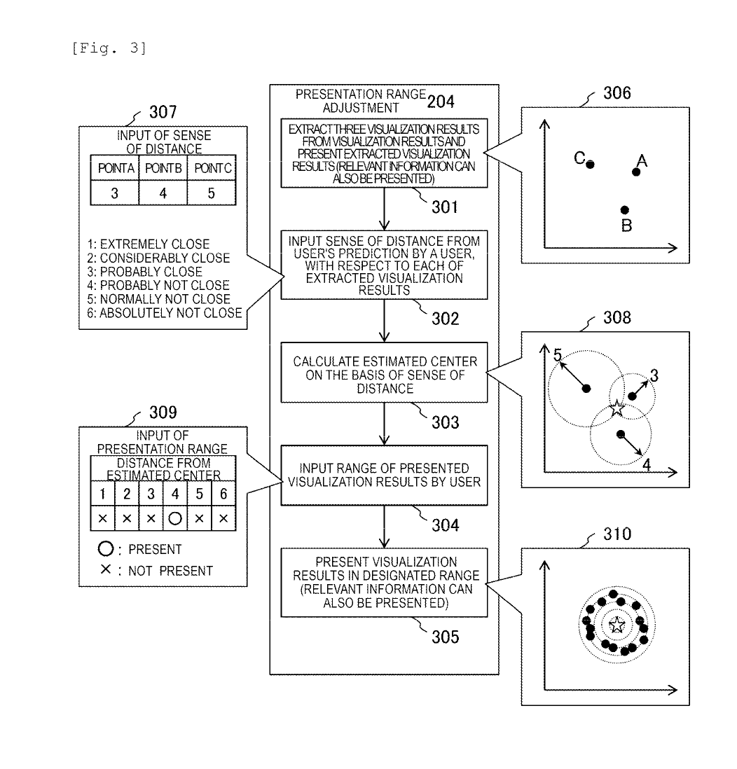

Next, the operation of the simulation system according to the present example will be described with reference to a flow chart of FIG. 2.

First, initial setting 201 is performed before simulation is performed. Specifically, a user inputs initial setting information from the user input unit 103, and this information is transmitted to the initial setting unit 106 through the interface units 104 and 105. The initial setting unit 106 acquires the transmitted initial setting information, and stores the information in the memory 1004 or the storage 1005 as information required for the simulation. Meanwhile, contents of the initial setting information include an attribute value of an agent and an environment variable in ABS, information regarding the execution operation of the simulation, and the like.

When the initial setting 201 is completed, simulation processing 202 is performed. This processing is realized by the simulation processing unit 107. Here, ABS is performed a plurality of times by changing an initial value and the like, and thus different simulation results are generated.

Next, the process of result visualization 203 is performed on the generated simulation results. This process is realized by the visualization unit 108. For example, a process of extracting the amount of features of each of the plurality of simulation results and creating a scatter diagram is performed. Meanwhile, each plot of the scatter diagram is called a visualization result.

As final processing, presentation range adjustment 204 is performed. This processing is realized by the user evaluation analysis unit 109 and the presentation range adjustment unit 110, and a presentation range of the visualization result is determined by being adjusted interactively with a user.

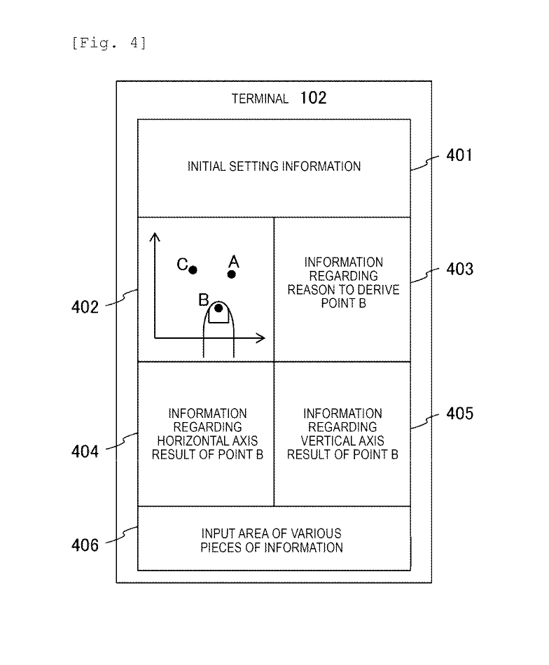

Hereinafter, the operation of the simulation system 100 in the presentation range adjustment 204 will be described in detail with reference to FIG. 3. FIG. 3 illustrates a more specific operation flow of the presentation range adjustment 204 as step 301 to step 305.

First, in the first step 301, for example, three visualization results are extracted from the visualization results obtained in the result visualization 203, and the extracted results are presented to a user as samples. The extraction is realized by the presentation range adjustment unit 110 illustrated in FIG. 1, and the extracted visualization results are transmitted to the result presentation unit 111 through the interface units 104 and 105 and are finally presented to a user. Meanwhile, as a method of extracting the visualization results, the visualization results may be randomly extracted, or may be selected so that, for example, Euclidean distances between the three visualization results become equal to each other. For example, the extracted results are displayed on the result presentation unit 111, like points A to C plotted on coordinates shown in a balloon 306. Examples of a coordinate axis include an axis of the length of congestion and an axis of an average speed of a vehicle, for example, in a case of traffic simulation, and include an axis of an output voltage and an axis of the size of a ripple, for example, in a case of simulation of a circuit. It is preferable that each of the axes is standardized so that evaluation can be performed by a score of a dimensionless quantity in the next step.

In the next step 302, a user inputs a sense of distance from a user's prediction with respect to each of the extracted three visualization results. This information is input from the user input unit 103, and is transmitted to the user evaluation analysis unit 109 through the interface units 104 and 105. Here, the user's prediction means a simulation result which is considered to be most “probable” by the user himself or herself. Meanwhile, a case where it is difficult to specify a sense of distance from a user's prediction from only the coordinates of the presented scatter diagram is also considered. Consequently, with respect to each of the extracted visualization results, detailed information of the result, a factor leading to the result, and the like are also able to be presented from the result presentation unit 111. Thereby, the user can easily determine whether or not the result is a “probable” result. Meanwhile, in the present example, the sense of distance determined by the user is input to the user input unit 103 as a score. As illustrated in a balloon 307 of FIG. 3, a case of being extremely close to a user's prediction is set to an evaluation score of 1, a case of being considerably close to a user's prediction is set to an evaluation score of 2, a case of being probably close to a user's prediction is set to an evaluation score of 3, a case of being probably not close to a user's prediction is set to an evaluation score of 4, a case of being normally not close to a user's prediction is set to an evaluation score of 5, and a case of being absolutely not close to user's prediction is set to an evaluation score of 6. In this manner, the evaluation on the user's samples is performed using the nearness to the user's prediction as an index.

In the next step 303, an estimated center of the user's evaluation on the sample is calculated on the basis of the sense of distance which is input by the user. This operation is realized by the user evaluation analysis unit 109, and the calculated result is transmitted to the presentation range adjustment unit 110. As a method of calculating the estimated center, for example, as illustrated in FIG. 3, circles having a size proportional to the scores of a sense of distance are drawn on the scatter diagram, centering on the respective visualization results. Then, each of the circles is gradually enlarged, and a method of determining a region where the circles overlap each other to be the estimated center is considered.

In the next step 304, a range of a visualization result to be presented is input by the user. This information is input from the user input unit 103, and is transmitted to the presentation range adjustment unit 110 through the interface units 104 and 105 and the user evaluation analysis unit 109. Here, the range of the visualization result is defined as a distance from the estimated center. For example, as illustrated in FIG. 3, when only a distance of 4 is marked with “o” (when only the distance of 4 is selected), a simulation result with a range of equal to or greater than 3 and less than 4 is presented. Meanwhile, the distance in this step is determined with respect to the range of the visualization result which is input by the user at the same ratio of the size of the circle to each score, shown in the above-mentioned step 303, which is input by the user.

In the final step 305, a visualization result which is in the range designated in step 304 is presented to the user. Main processing in this step is realized by the presentation range adjustment unit 110. More specifically, the coordinates of the estimated center in the above-mentioned scatter diagram and information equivalent to the distances of 3 and 4 are transmitted to the presentation range adjustment unit 110. The presentation range adjustment unit 110 extracts visualization results which are positioned at a distance of equal to or greater than 3 and less than 4 from the estimated center, from all of the visualization results, on the basis of these pieces of information. The extracted visualization results are transmitted to the result presentation unit 111 through the interface units 104 and 105, and are finally output to the result presentation unit 111 as a group of simulation results and are presented to the user. Meanwhile, similarly to the above-mentioned step, with respect to each of the extracted visualization results, detailed information of the result, a factor leading to the result, and the like are also able to be presented. This is for the purpose of increasing the probability of new awareness, such as a hidden tendency for the extracted results, being induced.

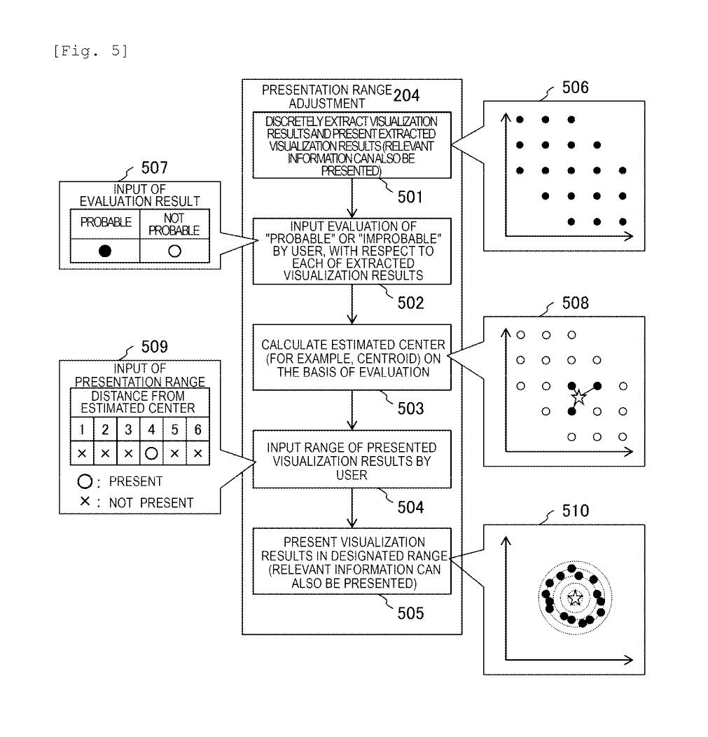

Next, an example of a screen layout displayed on the user I/F 1011 of the terminal device 102 will be described with reference to FIG. 4. In FIG. 4, a presentation region 401 is a presentation region of initial setting information, and is a region for presenting a setting result of the initial setting 201. A presentation region 402 is a presentation region of a visualization result, and is a region for presenting a processing result of the presentation range adjustment 204. Presentation regions 403 to 405 are regions indicating detailed information of the visualization result presented in the presentation region 402. As illustrated in FIG. 4, for example, when a user touches a point B in the presentation region 402 using his or her finger, information regarding a reason to derive the point B is presented in the presentation region 403, information regarding a horizontal axis result of the point B is presented in the presentation region 404, and information regarding a vertical axis result of the point B is presented in the presentation region 405. In addition, a region 406 is a region for inputting various pieces of information. For example, the initial setting information in the initial setting 201, the information of the sense of distance in the presentation range adjustment 204, and the like are input through a touch panel from the region.

By the above operation, the simulation system according to the first example of the invention can visualize a simulation result, and can interactively adjust a presentation range of a visualization result in response to a user's request.

Meanwhile, in the present example, the number of visualization results which are first presented to a user as samples is three, but the invention is not limited thereto. The number of visualization results may be two or more, and it is also possible to present more visualization results. It is possible to expect an improvement in the prediction accuracy of an estimated center by presenting more visualization results. On the other hand, the presentation of more visualization results leads to an increase in the number of times of a user's evaluation, and thus it is preferable that an appropriate number of visualization results are determined by a balance with prediction accuracy.

In addition, in the present example, as a presentation range of a visualization result designated by a user, a distance from an estimated center is set to equal to or greater than 3 and less than 4. This intention is to induce new awareness by presenting results separated from each other at a certain degree of distance with respect to simulation results which are predicted by a user. Naturally, when it is desired to view a result which is closest to a user's prediction, a distance of equal to or less than 1 may be designated. In this manner, it is preferable that a presentation range to be designated is changed in accordance with which result is desired to be viewed.

### SECOND EXAMPLE

In the present example, a description will be given of an example of a simulation system allowing a user to adjust a presentation range of a visualization result more easily.

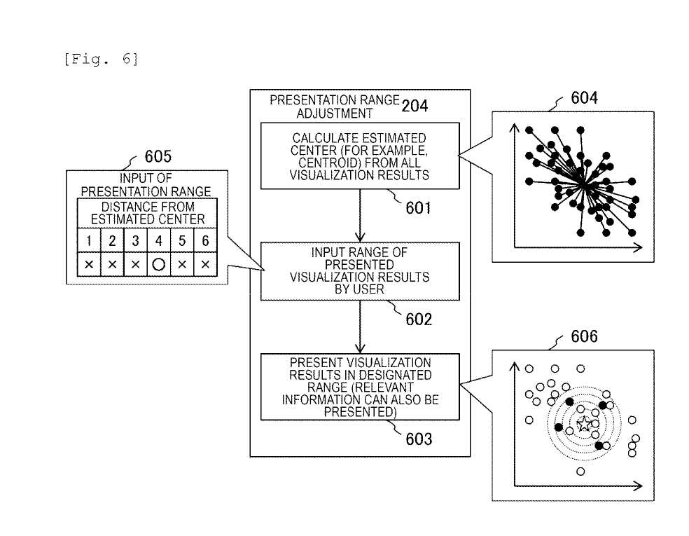

In the above-mentioned first example, a method of performing evaluation by scoring a visualization result is provided as a method for adjusting a presentation range of a visualization result. This method is effective in a case where a user easily gives a score, but a case where it is difficult to give a score depending on the contents of simulation is also expected. Consequently, in the present example, a user's evaluation is classified into only two types of “probable” and “improbable”. Meanwhile, the present example is the same as the first example in basic portions such as the configurations of functional blocks and a flow of an operation outline, and is different from the first example only in an operation flow of the presentation range adjustment 204. Hereinafter, the operation flow of the presentation range adjustment 204 will be described with reference to FIG. 5.

First, in the first step 501 of FIG. 5, as illustrated in a balloon 506, the visualization results obtained in the result visualization 203 are discretely extracted, and are presented as samples. The reason for discretely extracting the visualization results is to be able to present the visualization results over a wide range and to be able to reduce the number of times of a user's evaluation.

In the next step 502, a user inputs a sense of distance from a user's prediction with respect to each of the extracted visualization results. The present example is different from the above-mentioned first example illustrated in FIG. 3 in that a score to be input is classified into only two types of “probable” and “improbable” as illustrated in a balloon 507.

In the next step 503, an estimated center is calculated on the basis of the sense of distance which is input by the user. As a method of calculating the estimated center, for example, as illustrated in a balloon 508 of FIG. 5, a polygon constituted by visualization results evaluated to be “probable” is considered, and a method of setting the centroid thereof to be an estimated center is considered.

The next step 504 and the subsequent steps are the same as the operations in the first example, and thus a description thereof will be omitted here.

By the above operation, the simulation system according to the second example of the invention can adjust a presentation range of a visualization result more easily.

Meanwhile, in the present example, it is possible to expect an improvement in the prediction accuracy of an estimated center as the number of visualization results first presented to a user is larger. On the other hand, the presentation of more visualization results leads to an increase in the number of times of a user's evaluation, and thus it is preferable that an appropriate number of visualization results are determined by a balance with prediction accuracy.

### THIRD EXAMPLE

In the present example, a description will be given of an example of a simulation system allowing a user to adjust a presentation range of a visualization result more easily.

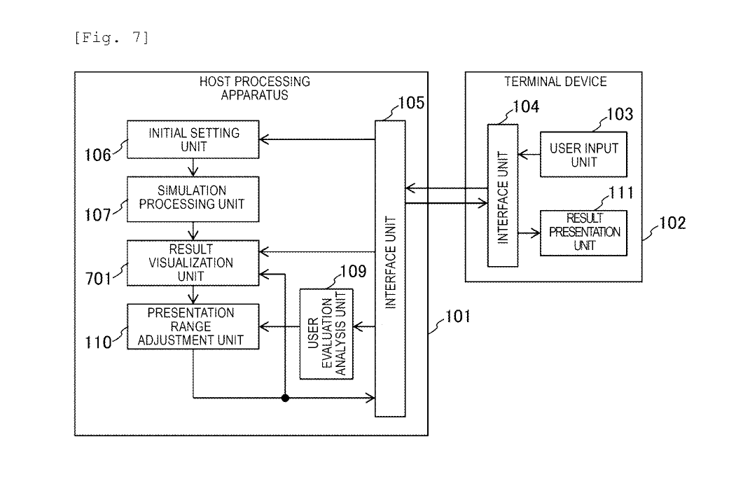

In the above-mentioned first and second examples, a method of causing a user to perform evaluation on a visualization result is provided as a method for adjusting a presentation range of a visualization result. On the other hand, in the present example, there is no user's evaluation, and a user only inputs a presentation range of a visualization result. Meanwhile, the present example is the same as the first and second examples in basic portions such as the configurations of functional blocks and a flow of an operation outline, and is different from the first and second examples only in an operation flow of the presentation range adjustment 204. Hereinafter, the operation flow of the presentation range adjustment 204 will be described with reference to FIG. 6.

First, in step 601 of FIG. 6, an estimated center is calculated on the basis of all visualization results. As a method of calculating the estimated center, for example, as illustrated in a balloon 604 of FIG. 6, a polygon constituted by all visualization results is considered, and a method of setting the centroid thereof to be an estimated center is considered.

The next step 602 and the subsequent steps are the same as the operations in the first and second examples, and thus a description thereof will be omitted here.

By the above operation, the simulation system according to the third example of the invention can visualize a simulation result, and can adjust a presentation range of a visualization result more easily.

Meanwhile, in the present example, all visualization results are used to calculate an estimated center, and this is because the prediction accuracy of the estimated center is considered. In a case where it takes time to perform processing due to a large calculation amount, all visualization results do not necessarily have to be used.

### FOURTH EXAMPLE

In the above-mentioned first to third examples, visualization results positioned at nearby coordinates on a scatter diagram ideally have the same sense of distance when seen by a user. However, it is also considered that the visualization results actually have greatly different senses of distance. In this case, in visualization results to be finally presented, there is the possibility of variations in a sense of distance occurring. The reason why senses of distance are different from each other in nearby coordinates is because a user recognizes new indexes other than the two axes of the scatter diagram as a result of viewing detailed information of the visualization results and is influenced by the indexes.

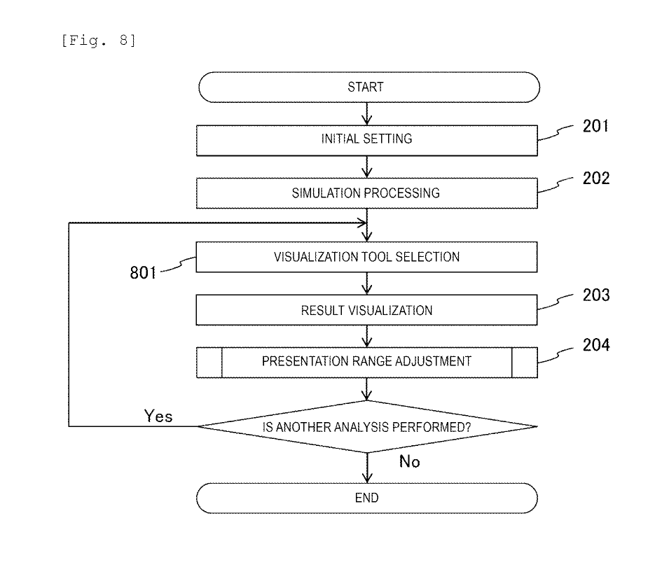

Consequently, in a simulation system according to the present example, multifaceted evaluation is performed by preparing a plurality of scatter diagrams to thereby realize the presentation of visualization results having higher accuracy. Hereinafter, the operation of the simulation system according to the present example will be described with reference to FIGS. 7 to 9.

FIG. 7 is a functional block diagram of the simulation system according to the present example. The simulation system according to the present example is the same as that in the first example in that the simulation system includes a host processing apparatus and a terminal device. In FIG. 7, a block 701 is a result visualization unit. The other units are the same as those in the first example illustrated in FIG. 1 and perform the same operations.

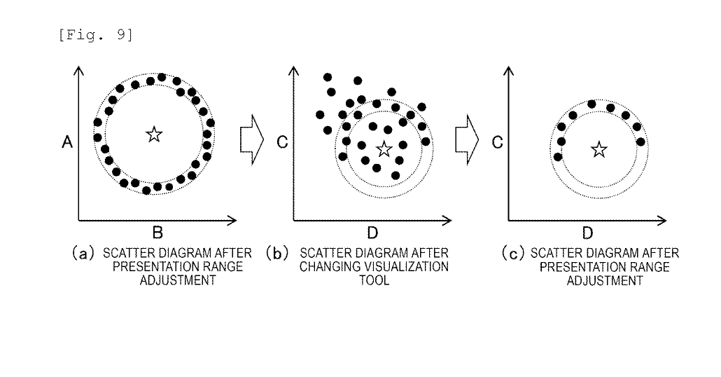

Next, the operation of the simulation system according to the present example will be described with reference to a flow chart of FIG. 8. Meanwhile, in FIG. 8, initial setting 201, simulation processing 202, result visualization 203, and presentation range adjustment 204 are the same as those in the first example illustrated in FIG. 2, and thus a detailed description thereof will be omitted here.

In the simulation system according to the present example, when the initial setting 201 and the simulation processing 202 are completed, visualization tool selection 801 is performed. First, a user inputs selection information of a visualization tool from a user input unit 103, and this information is transmitted to the result visualization unit 701 through interface units 104 and 105. The result visualization unit 701 includes a plurality of visualization tools, and selects the visualization tool on the basis of the transmitted selection information of the visualization tool.

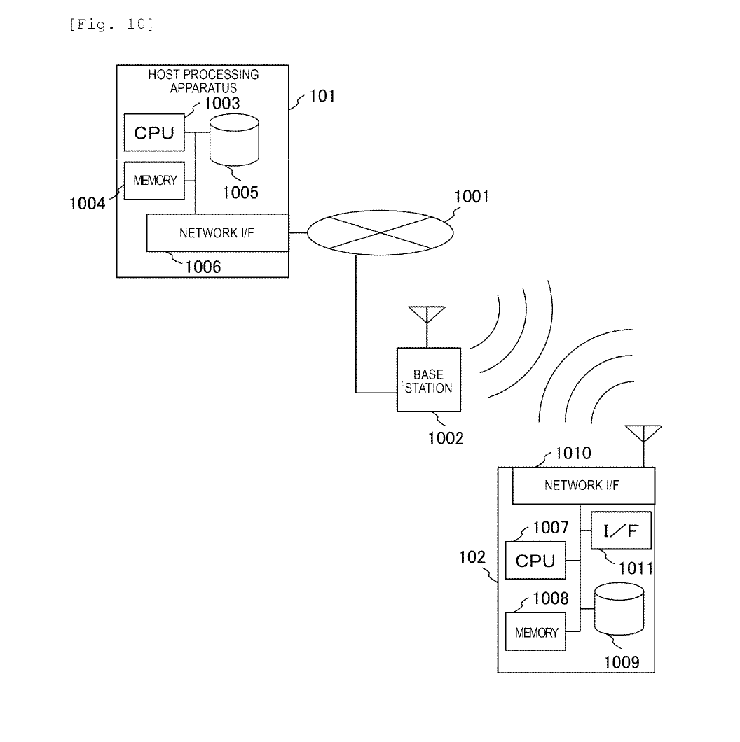

Thereafter, the process of the result visualization 203 is performed using the selected visualization tool, and subsequently, the process of the presentation range adjustment 204 is performed. The processes are the same as, for example, the operations shown in the first example, and thus a detailed description thereof will be omitted here. Meanwhile, presentation ranges of visualization results obtained in the processes up to the moment have distribution, for example, as illustrated in (a) of FIG. 9, and are the same as those of the results shown in the first example.

Next, a user determines whether or not to perform another analysis. When it is desired to perform analysis using another visualization tool, the flow returns to the visualization tool selection 801 to repeat the subsequent processes again. Here, simulation results targeted by the second result visualization 203 are not all of the results, and are only results obtained in the first presentation range adjustment 204, in other words, only a plot illustrated in (a) of FIG. 9. Accordingly, a scatter diagram obtained in the second result visualization 203 has a distribution illustrated in (b) of FIG. 9. Meanwhile, the reason why the distribution of results is diffused is because an evaluation axis in the scatter diagram is changed.

Next, as a result of performing the second presentation range adjustment 204 on the visualization results having the distribution illustrated in (b) of FIG. 9, a distribution illustrated in (c) of FIG. 9 is generated. As described above, it can be understood that the number of visualization results presented is reduced as compared with that in (a) of FIG. 9 because the first presentation range adjustment 204 is targeted. This means that it is possible to realize the presentation of visualization results having high accuracy which is an object of the present example.

By the above operation, the simulation system according to the fourth example of the invention can visualize a simulation result, and can present a visualization result having higher accuracy.

Meanwhile, in the present example, the visualization tool selection 801 and the subsequent operations are performed twice. However, the invention is not limited thereto, and the operations may also be repeated a larger number of times. In this case, it is possible to expect the presentation of a visualization result having higher accuracy. On the other hand, there is a concern that the selection of a larger number of visualization tools may result in a significant reduction in the number of visualization results which are finally presented to a user, and thus it is preferable that an appropriate number of visualization results are determined by a balance with presentation accuracy.

Meanwhile, in the first to fourth examples, it is ideal that a vertical axis and a horizontal axis in a scatter diagram have the same sensitivity of a sense of distance. However, a case where a vertical axis and a horizontal axis have significantly different sensitivities of a sense of distance is also considered. In this case, it is possible to perform calibration for measuring a user's sensitivity in advance and adjusting a scale of the axis in accordance with the result.

In addition, in the first to fourth examples, a method of causing a user to designate a presentation range of a visualization result on an executed simulation result is provided. However, when an excessively large number of simulations are performed, a processing time lengthens, and there is the possibility of practicality being significantly reduced. As a countermeasure, a method of reducing the number of simulations to be performed first, causing a user to designate a presentation range of a visualization result, and then additionally performing simulation for obtaining a result close to the range is considered. In order to realize this operation, for example, initial setting may be adjusted so that the result becomes close to the presentation range designated by the user.

### REFERENCE SIGNS LIST

101 HOST PROCESSING APPARATUS
102 TERMINAL DEVICE
103 USER INPUT UNIT
104 INTERFACE UNIT
105 INTERFACE UNIT
106 INITIAL SETTING UNIT
107 SIMULATION PROCESSING UNIT
108 RESULT VISUALIZATION UNIT
109 USER EVALUATION ANALYSIS UNIT
110 PRESENTATION RANGE ADJUSTMENT UNIT
111 RESULT PRESENTATION UNIT
201 INITIAL SETTING
202 SIMULATION PROCESS
203 RESULT VISUALIZATION
204 PRESENTATION RANGE ADJUSTMENT
401 PRESENTATION REGION OF INITIAL SETTING INFORMATION
402 PRESENTATION REGION OF VISUALIZATION RESULT
403 DETAILED INFORMATION PRESENTATION REGION OF VISUALIZATION RESULT
404 DETAILED INFORMATION PRESENTATION REGION OF VISUALIZATION RESULT
405 DETAILED INFORMATION PRESENTATION REGION OF VISUALIZATION RESULT
406 INPUT REGION OF VARIOUS INFORMATION
701 RESULT VISUALIZATION UNIT
801 VISUALIZATION TOOL SELECTION

1. A simulation system comprising:
a processing apparatus that performs simulation; and
a user interface that displays a plurality of simulation results as samples and receives an input of information on a user's evaluation with respect to each of the displayed results,
wherein a group of simulation results are output on the basis of the input information.

2. The simulation system according to claim 1,
wherein the display of the result is a scatter diagram in which each result is plotted,
wherein the user's evaluation is performed using nearness between each result and a user's prediction as an index, and
wherein when the group of simulation results are output on the basis of the input information, a center of a user's evaluation with respect to the displayed result on the basis of the user's evaluation is obtained, and the group of simulation results are output on the basis of a distance from the obtained center.

3. The simulation system according to claim 2,
wherein the user interface further receives information of a distance from the center from a user, and
wherein when a group of simulation results are output on the basis of the input information, the group of simulation results are output on the basis of the received information of the distance.

4. The simulation system according to claim 1, wherein the processing apparatus is a central processing unit of a server device.

5. The simulation system according to claim 1, wherein the user interface is a touch panel of a portable terminal.

6. A simulation method comprising:
performing simulation by a processing apparatus;
displaying a plurality of simulation results as samples on a display device, and receiving an input of information on a user's evaluation with respect to each of the displayed results by a user interface; and
outputting a group of simulation results on the basis of the input information.

7. The simulation method according to claim 6,
wherein the display of the result is a scatter diagram in which each result is plotted,
wherein the user's evaluation is performed using nearness between each result and a user's prediction as an index, and
wherein when the group of simulation results are output on the basis of the input information, a center of a user's evaluation with respect to the displayed result on the basis of the user's evaluation is obtained, and the group of simulation results are output on the basis of a distance from the obtained center.

8. The simulation method according to claim 7,
wherein the user interface further receives information of a distance from the center from a user, and
wherein when a group of simulation results are output on the basis of the input information, the group of simulation results are output on the basis of the received information of the distance.

9. The simulation method according to claim 6, wherein the processing apparatus is a central processing unit of a server device.

10. The simulation method according to claim 6, wherein the user interface is a touch panel of a portable terminal.
